(19) United States
(12) Patent Application Publication
(10) Pub. No.: US 2006/0041908 A1
(43) Pub. Date: Feb. 23, 2006

(54) Method and apparatus for dynamic search of video contents

(76) Inventors: Tae Hyoung Kim, Seoul (KR); Kyoung Ro Yoon, Seoul (KR); Sung Bae Jun, Seoul (KR)

Correspondence Address: Lee Hong Degerman Kang & Schmadeka, 801 S. Figueroa Street, 14th Floor, Los Angeles, CA, 90017, US

(21) Appl. No.: 10/540,426

(22) PCT Filed: Dec. 26, 2003
(86) PCT No.: PCT/KR03/02845

§ 371 Date: Jun. 24, 2005

(30) Foreign Application Priority Data
Dec. 27, 2002 (KR) 1020020084780

(51) Int. Cl. H04N 5/445; H04N 7/173; G06F 13/00; G06F 3/00

(52) U.S. Cl. 725/52; 725/53; 725/89; 725/88; 725/102

(57) ABSTRACT

A dynamic searching method and apparatus of video contents is disclosed. The dynamic searching apparatus of video contents according to the present invention determines a normal replay section and a fast forward replay section the shot index information with considering current replay location and shot index information and replays the video contents from the current replay location at the determined corresponding speed according to the sections alternatively so as to replay video contents. Here, audio is replayed along with the video in the normal replay section.

### TECHNICAL FIELD

The present invention relates to a recoding/reproducing apparatus, and more particularly, to a dynamic searching method of video contents.

### BACKGROUND ART

With advance of mass media and easy production of multimedia contents, people come in contact with a great deal of media everyday. As the amount of media contents gets larger, an automatic sorting system of user's wished data is required, and the methods to solve the requirement are being actively studied. Particularly, with advance of digital technology, the video contents are stored digitally and sold in a market. If the digital broadcast is popularized, the digitalization of the video contents will be further accelerated.

In relation to these digital video contents, some users may want to see sports-related scenes of news, others may want to see stock-related scenes of the news, and others may want to see the scenes of a specific character in a show program. To satisfy the various requirement of the users, various studies are in progress actively.

Some users may want to know an entire scenario of the video contents in a limited time. It is the “highlight” that implements such a requirement. In general, the highlight can be regarded as new contents made by assorting important scenes in the video contents. It is exemplified by “sports highlight”, “movie preview”, “headline news”, etc. In fact, however, to extract a highlight from video contents is very difficult to automated according to today's technology. Accordingly, most of people extract a highlight from video contents manually. As mentioned above, as the amount of the media is dramatically increased, it requires a lot of time and cost to manually create a highlight for all the video contents so that it is rarely possible to be actually commercialized. Accordingly, the automation system is required for a user to understand overall contents.

Generally, when a user would like to skip to a predetermined location on video contents, a key frame can be usually used. A video summary made using the key frame helps a user skip quickly to a user's wished scene. However, since a user needs a lot of key frames to easily find a user's wished location and it is difficult to display a lot of key frames limited display space, the user is required to select items many times. It is very inconvenient for the user. In addition, generally, it is difficult for the user to understand the overall video contents.

Recently, various video indexing techniques have been being studied to find a user's wished scene on a digital video. In other words, the methods such as a method of finding a scene of a specific character, recognizing who the character is and indexing to the information on the character's appearance, and a method of extracting main scenes from a movie or sports and indexing to the extracted scenes have been being studied. However, the video has various genres and different data that are indexed according to genres. Accordingly, the automation system that can extract the meaningful information for the user with high precision is very difficult to make according to today's technology.

Meanwhile, in contrast to analogue video, the digital video can prevent video quality from degeneration by using fast-forwarding/fast-rewinding functions.

In a fast forward method used widely by the digital video, the number of frames decoded per a unit time is increased, so that only some of them are displayed or some of them are skipped and the frames are decoded to display.

However, the method of increasing the number of frames decoded per a unit time affects on the maximum speed according to the performance of the terminal. Accordingly, in the fast-forwarding/fast-rewinding functions of the digital video, generally, the method of skipping some portion and decoding and displaying the frames is widely used. Among the conventional arts, the fast-forwarding/fast-rewinding functions of the digital video is the most reasonable solution for the requirement of the user who wants to know entire contents in a limited time or move to a user's wished location. However, when a predetermined portion is skipped, usually it is skipped with a predetermined time interval so that the user may lost a user's wished scene or unimportant scenes may be replayed comparatively too much.

Meanwhile, in the conventional moving picture variable speed replay method for searching a video, the variable speed is fixed constantly for all the period of replaying the moving picture. However, when the moving picture is replayed fast or slowly using variable speed replay technique, the visual characteristics of the user are not satisfied.

For example, when the moving picture is fast-forwarded with a constant speed, the screen is so fast changed that the user cannot recognize the moving picture in the period in which the moving picture is changed fast. The screen is so slowly changed that the user feels bored and cannot feel a fast forward in the period in which the moving picture is changed slowly.

On the contrary, when the moving picture is slowly replayed, the screen is fast changed though the user wants slow replay in the period in which the moving picture is changed fast. In the period in which the moving picture is changed slowly, the screen is so slowly changed that the user feels very bored since the screen is much more slowly changed.

Generally, the fast forward has an object of quick search while the slow replay has an object of looking into a specific scene in detail. In fact, considered in the view point of user's view, the user expects the scene is more slowly replayed in the period in which the scene is changed fast and the user expects the scene is faster replayed in the period in which the scene is changed slow.

Accordingly, if the speed of the moving picture is automatically and adaptively controlled by adaptively changing the degree of the variable speed according to a picture change rate of the variable speed period, the problem described above is solved.

An automatic adaptive speed control technique has been suggested. The technique includes the steps of: detecting a cut, and controlling the replay speed faster or more slowly according to the image moving rate by using the number of frames between a cut and another cut and the image difference between neighboring frames in the replay period, so that the speed in the variable speed period is adaptively changed suitable for the visual characteristics of a human according to the dynamic characteristics of the image.

For example, the concept of a system for automatically controlling the replay speed according to the complexity of screen has been suggested. This system has been suggested as a display system for automatically controlling the replay speed according to the moving rate of a scene. However, in this technique, the scene change is defined as a difference image. “Screen complexity” based on the image difference between neighboring frames is used.

However, when a motion is defined as a difference image, since such a technique should compare all the pixels, the process time gets longer. In the technique in which the screen complexity is defined as a difference image, it is determined that the motion of an object is fast if the color difference between the object and the background is large from even though the object motion is slow. The corresponding object is slowly replayed so that a user's wished replay speed is not achieved.

Also, in the viewpoint of the actual contents progress of the video, all the difference of previous and next images does not reflect the meaning of the contents progress fully. According to the story progress as well as the mere image difference, the complexity of the contents can be actually felt differently. It is failed to notice.

For example, in the case of soap opera, a dialogue scene can be continued boringly but if the location of a shooting camera is frequently changed, the image difference between previous and next images is large. This portion can be determined to be complex screen and replayed slowly. However, even though the dialogue scene is boringly continued for a long time period, this portion would better be fast-forwarded.

Consequently, it is difficult to automatically estimate and determine the “complexity of contents” with only different image according to genre, application, and contents of the moving picture, which reflects the meaning of the contents. In the viewpoint of the actual contents progress of the video, the “complexity of contents” of the video reflects actual human felt “complexity of contents” when motion information, shot information, character face information (specific object detection information that is a core of contents progress), text information, and audio information, etc. are integrally considered.

As described above, with growth of the amount of multimedia contents, the automation system for assorting the user's wished data is required.

Recently, as a new personal video recording device (that can record and reproduce a video) called as a personal video recorder (PVR) is developed, such an automation system is very frequently required.

In the conventional art, the fast forward function is used to quickly skip to the user's wished location and a video skimming technique for constituting an automatic summarization system was introduced.

However, the conventional fast forward function failed to help the user easily skip to the user's wished location or some users felt vertigo due to too fast scene progress.

It was desirable to use the video skimming function as automatic video summarization function rather than as means to help a user skip to the user's wished location.

Particularly, since a video navigation function using tree structure based on a complex video analysis function or 1- or 2-dimentional key frame requires a complex user interface, it is difficult for a general user excepting an expert to use the video navigation function under TV environment and interface design is very complex.

As described above, a video contents search requirement is used to edit the contents the user possesses as well as simple browsing. In other words, users want to see the video contents with excluding advertisements or uninterested things and want to edit and store only the user's wished portion separately.

Today, the PVR records an on-air stream on digital media, allows a user to see the corresponding contents again anytime, randomly access to the user's wished location, and provides a high speed fast forward function which is impossible in an analogue video.

Accordingly, required is a video search system that effectively the limitation and problems of the conventional video search technique and can be included in a digital video recording/reproducing apparatus such as a PVR.

### DISCLOSURE OF THE INVENTION

Accordingly, the present invention is directed to a dynamic searching method and apparatus of video contents that substantially obviates one or more of the problems due to limitations and disadvantages of the related art.

An object of the present invention is to provide a dynamic searching method and apparatus of video contents that has a dynamic search function for searching a video stream quickly using shot index information and helping a user skip quickly to the user's wished location.

Another object of the present invention is to provide a dynamic searching method and apparatus of video contents that makes structure and implementation of an index generator simple by making both shot structure and scene structure unnecessary, is convenient to skip to a wished location in comparison with the conventional skimming technique, does not lose the user's wished location by replaying entire stream, and overcomes the problem of vertigo caused by the replayed screen and the problem in which the user could not skip exactly to the user's location when using the convention fast forward function.

A further object of the present invention is to provide a dynamic searching method and apparatus of video contents that helps a user see all the contents and easily and quickly skip to the user's wished location on the basis of very simple index such as shot information on video contents.

Still another object of the present invention is to provide a digital video recording/reproducing apparatus that can be included in a PVR and can automatically and repeatedly perform normal replay and the fast forward of a video on the basis of shot index information on video contents.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, according to a first embodiment of the present invention, a dynamic searching method of video contents includes the steps of: (a) determining a normal replay section and a fast forward replay section with considering shot index information and a current replay location; and (b) replaying video contents from the current replay location at a corresponding speed according to the determined sections.

According to the method, the step (b) includes the steps of: (b-1) fast-forwarding the video contents from the current location at a high speed as fast as the replay speed of the fast forward replay section; and (b-2) replaying the video contents at a normal speed as fast as the replay speed of the normal replay section when a replay location of the video contents is a start location of the normal replay section.

According to the method, in the normal replay section, audio contents as well as the video contents are replayed at a normal speed.

According to the method, the replay mode is switched from the normal replay to the fast forward replay in any one case selected from the group consisting of a case that a user clearly requests the fast forward replay during the normal replay in a dynamic search mode, a case that the user requests a dynamic search function during the normal replay, and a case that a predetermined amount of the video contents has been completely replayed at a normal speed in a dynamic search.

According to the method, the replay mode is switched from the fast forward replay to the normal replay in any one case selected from the group consisting of a case that a user clearly requests the normal replay during the fast forward in a dynamic search mode, a case that a replay location of the video contents reaches a start location of a shot whose normal replay section is long during the fast forward for the dynamic search.

According to a second embodiment of the present invention, a dynamic searching method of video contents includes the steps of: (a) when a dynamic search is requested during a video browsing, determining a normal replay section with considering shot index information and a current replay location of video contents; (b) fast-forwarding the video contents at a high speed from the current replay location to a start location of the normal replay section; (c) replaying the video contents at a normal speed as fast as the replay speed of the normal replay section when a replay location of the video contents is a start location of the normal replay section; and (d) when the replay of the video contents on the normal replay section is completed, repeatedly performing the steps (a) to (c).

According to a third embodiment of the present invention, a dynamic searching apparatus of video contents includes: a media storage unit for storing video contents; an index storage for storing shot index information on the video contents; an index generator for generating shot index information of the video contents; a controller for determining a normal replay section and a fast forward replay section by using the shot index information, and controlling to replay the video contents according to the determined sections; and an output unit for outputting the replayed video contents.

According to the apparatus, the controller includes: a command interpreter for generating commands for replaying control, recording control, nonlinear video browsing control and indexing control to provide functions of record, index generation, replay and dynamic search; a record controller for controlling to store the video contents in the media storage unit; a replay controller for outputting the video contents to the output unit, controlling to replay the entire video contents, and providing a nonlinear video browsing function and fast-forward/fast-rewind functions; and an index manager for delivering storage information on the video contents to the replay controller to provide the fast-forward/fast-rewind functions, and providing the shot index information to the nonlinear video browsing controller.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an example of shot index information;

FIG. 2 illustrates the concept of a dynamic searching method of the present invention;

FIG. 3 illustrates switching between a dynamic search mode and a replay mode in the present invention; and

FIG. 4 is a block diagram of a PVR system to which a dynamic searching method of video contents of the present invention is applied.

### BEST MODE FOR CARRYING OUT THE INVENTION

Hereinafter, preferred embodiments of the present invention will be described in detail with reference to accompanying drawings.

A video indexing technique of multimedia contents analysis techniques has been studied for a long time period. A shot segmentation technique of the technique is known as a video contents analysis technique with a very high precision. In the shot segmentation technique, the video contents are divided into shots that are a physical editing unit. In general, the shot segmentation technique has 95% or higher precision. The shot segmentation technique can be integrated in a personal video recorder (PVR). As an example, at the same time of record, the video contents are analyzed and a shot index can be generated using shot segmentation technique. Accordingly, in the present invention, it is assumed that a location to which a user wants to move to search or edit is usually a start location of a scene. Some portion is fast-forwarded at high speed and another portion is replayed at normal speed by using the shot segmentation information that can be applied regardless of the video genre. The audio information is also provided.

There can be various modifications in setting a speed of each section. Basically, long shots are replayed at normal speed and short shots are fast-forward at high speed. In the dynamic search function, fast forward and normal replay are performed repeatedly. The problem is overcome in which a user cannot skip exactly to a wished location in the conventional fast forward function by using the replay method. When the user's wished scene is within a fast forward replay section, it is difficult to recognize whether the user's wished scene past in skimming. The present invention provides means for skipping quickly to the user's wished exact location. The dynamic search function can operate under client-server environment and in a separate system, especially, a PVR.

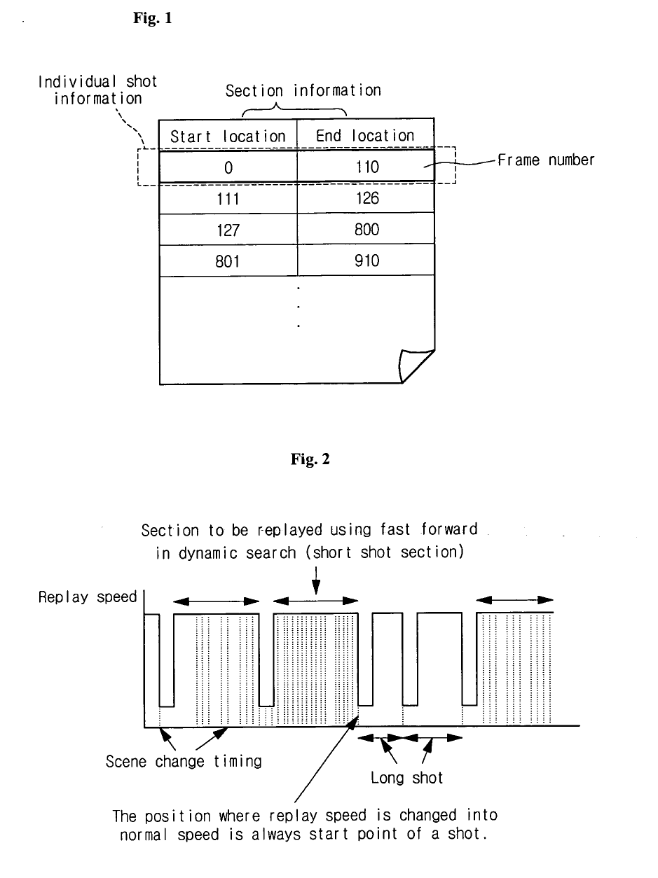

FIG. 1 illustrates an example of shot index information.

As shown in FIG. 1, the shot index includes a list of individual shot information. The individual shot information includes section information of a minimum shot. The shot section information includes a start location and an end location of a corresponding shot of the video contents.

The individual shot information a minimum section information (start location and end location). The individual shot information can include additional information (representative frame information, information of average motion amount, etc.). Elapsed time or length information can be calculated as “end location—start location”.

FIG. 2 illustrates an example of a dynamic searching method of the present invention.

As shown in FIG. 2, in the dynamic search function, a normal replay and a fast forward are automatically repeated at a user's request for dynamic search. At the user's request for dynamic search during video browsing, a video replay mode is switched into a fast forward mode and the corresponding video contents are fast-forwarded. At a predetermined time, the video replay mode is automatically switched into a normal replay mode and the corresponding video contents are replayed at normal speed for a predetermined time period. Then, the video replay mode is automatically switched into the fast forward mode again. Of course, at this time, audio is also replayed with the video in the normal replay mode. Here, in order to switch the video replay mode from the fast forward mode into the normal replay mode or from the normal replay mode into the fast forward mode, the following rule can be used.

First, the replay mode is switched from the normal replay into the fast forward replay in any one case selected from the group consisting of a first case (1-1) that a user clearly requests the fast forward replay during the normal replay in a dynamic search mode, a second case (1-2) that the user requests a dynamic search function during the normal replay, and a third case (1-3) that a predetermined amount of the video contents has been completely replayed at a normal speed in a dynamic search.

Next, the replay mode is switched from the fast forward replay into the normal replay in any one case selected from the group consisting of a first case (2-1) that a user clearly requests the normal replay during the fast forward in a dynamic search mode, a second case (2-2) that a replay location of the video contents reaches a start location of a shot whose normal replay section is long during the fast forward for the dynamic search.

In the above two first cases (1-1 and 2-1) that the user clearly requests the fast forward replay during the normal replay in a dynamic search mode or vice versa, the video replay mode is naturally switched since it is a response to the user's request to change the video replay mode.

As described above, when the dynamic search function is requested, since the fast forward replay is performed before the normal replay, the video replay mode is switched into fast forward replay mode in the second case (1-2). Since the dynamic search automatically switches the video replay mode to replay the video contents, the video replay mode is switched into the fast forward mode after a predetermined amount of the video contents has been completely replayed at the normal speed in the dynamic search.

In general, the user wants to skip advertisement to normally replay the video contents from its start location, begin to edit the video contents from the corresponding start location, or skip short scenes collected by a reporter to replay or edit an anchor scene, a diagram illustration scene or an interview scene from its start locations.

Therefore, under such an assumption, the dynamic search function of the present invention has the characteristics that a shot at the start location of most of the video contents, and an anchor scene, a diagram illustration scene and an interview scene in news are longer than advertisement scene and scenes collected by a reporter. When the current location of the video contents reaches the start location of the comparatively long shot, the video replay mode is automatically switched from the fast forward mode to the normal replay mode by using the characteristic, the current location of the video contents in the fast forward and shot index information at the same time. Accordingly, a user is allowed to pause the recording/reproducing system at an arbitrary location or normally replay the video contents from an arbitrary location by requesting the recording/reproducing system to pause at an arbitrary location or to normally replay the video contents from an arbitrary location. The present invention is can be used to exactly skip to the user's wished location and replay the video contents.

Here, the shot length is obtained from section information of the shot index. The criterion to determine whether the shot is long or short can be whether the shot is longer or shorter than a specific threshold or whether the shot is longer or shorter than an average of surrounding shots.

The third case (2-3) to switch the video replay mode from the fast forward mode into the normal replay mode may be used in dynamic search or not. This switch can be applied assuming that a shot index might be abnormally generated when a short segment is abnormally continued for a long time period. Here, the predetermined period can be set to be five minutes or ten minutes. In this case, it is ensured that the fast forward cannot be performed for more than five minutes or ten minutes. If the predetermined period is set to be infinity, the above-mentioned condition is ignored. Accordingly, the above-mentioned condition can be selectively used according to whether predetermined period exists or not.

In the third case (1-3) to switch the video replay mode from the normal replay mode into the fast forward mode, the predetermined amount can be interpreted in two ways. First, after the entire of a corresponding shot is replayed at a normal speed, the video replay mode is automatically switched from the normal replay mode into the fast forward mode. Second, after only the fixed amount (e.g. four seconds) of a corresponding shot is replayed at a normal speed regardless of the length of the corresponding shot, the video replay mode is automatically switched from the normal replay mode into the fast forward mode.

In other words, if the shot length to be normally replayed is 20 seconds, the video contents is normally relayed for 20 seconds in the first method while the video contents is normally relayed for 4 seconds and the remaining portion of the corresponding shot is fast-forwarded for remaining 16 seconds in the first method.

Here, the first method is for the user to fully understand the contents of the normally replayed shot. In the second method, since the normally replayed corresponding shot may not be the user's wished shot, the user determine whether the scene is the user's wished scene or not during the normal replay. If the scene is the user's wished scene, the user requests the system to do something. If the user does not request the system anything, the video replay mode is switched from the normal replay mode into the fast forward mode.

Such a dynamic search function includes three steps. Each of the steps will be described as follows.

The dynamic search function receives video dynamic search request.

First step: The start location and the length of the normal replay are selected considering the current replay location of the video contents and shot index information.

Second step: The video contents are fast-forwarded from the current location to the start location of the normal replay.

Third step: When the current location of the video contents is the same as the start location of the normal replay, the video replay mode of the video contents is switched into the normal replay mode. The amount (e.g. normal replay length) of video contents defined in the first step is replayed at the normal speed at which the video and the audio are replayed at the same time. Then, it proceeds to the first step, and the first through third steps are repeatedly performed.

By doing so, considering the current replay location of the video contents and shot index information, the normal replay section and the fast forward replay section are determined. The video contents are normally replayed and fast-forwarded repeated without any input from the user.

Here, the shot index information includes section information in a stream for an individual shot that is a physical editing unit of the video contents.

At this time, the video replay mode is switched from the normal replay mode into the fast forward mode in any one case selected from the group consisting of a first case (1-1) that a user clearly requests the fast forward replay of the video contents during the normal replay in a dynamic search mode, a second case (1-2) that the user requests a dynamic search function during the normal replay, and a third case (1-3) that a predetermined amount of the video contents has been completely replayed at a normal speed in a dynamic search. In automatically switching the video replay mode from the normal replay mode into the fast forward mode after a predetermined amount of the video contents is completely replayed at a normal speed in a dynamic search, the amount of the video contents to be replayed at a normal speed may be the entire selected shot or the amount designated in a first half of a selected shot regardless of shot length.

The video replay mode is switched from the fast forward mode into the normal replay mode in any one case selected from the group consisting of a first case (2-1) that a user clearly requests the normal replay of the video contents during the fast forward, and a second case (2-2) that a current replay location of the video contents reaches a start location of a shot whose length is long according to a predetermined rule during the fast forward for a dynamic search.

In automatically switching the video replay mode from the fast forward mode into the normal replay mode, the start location of the normal replay is the start location of a shot to be normally replayed that was determined in the first step. The shot to begin to be replayed at the normal speed is selected as a shot whose length is larger than a specific threshold. The length is estimated based on shot section information (start location and end location) in the shot index. For adaptive dynamic search, a shot whose division result is larger than a specific threshold is selected as a shot that is replayed at the normal speed during the fast forward. The division result is obtained by dividing the shot length by an average of lengths of surrounding shots.

To prevent the user from feeling vertigo due to too long fast forward, the video replay mode can be additionally switched from the fast forward mode into the normal replay mode in case the video contents are fast-forwarded for more than a predetermined period defined in the dynamic search.

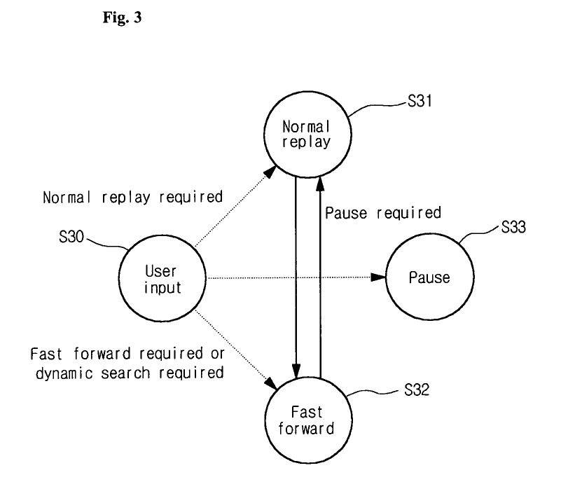

The switching between the replay modes can be summarized as shown in FIG. 3. Since there can exist various functions provided by the video recording/reproducing apparatus, the essential switching between video replay modes relevant to the present invention will be described. S30 is a user input stage. S31 is a normal replay stage. S32 is a fast forward stage. S33 is pause stage. The transition from S31 to S32 occurs after a predetermined amount of the video contents is replayed at the normal speed in a dynamic search mode. The transition from S32 to S31 occurs in case a current replay location of the video contents reaches a start location of a shot whose length is longer according to a predetermined rule during the fast forward for a dynamic search, or in case the video contents are fast-forwarded for more than a predetermined period defined in the dynamic search.

As shown in FIG. 3, the video replay mode is switched from the normal replay mode into the fast forward mode at a user's request for the dynamic search. The video recording/reproducing system is automatically changed into the normal replay mode, considering the shot index information and the current replay location of the video contents. The video recording/reproducing system is changed into the fast forward mode again during the normal replay, integrally considering the shot index information, the current replay location of the video contents, and length of normal replay section. The video recording/reproducing system repeats such operation until the user inputs any request.

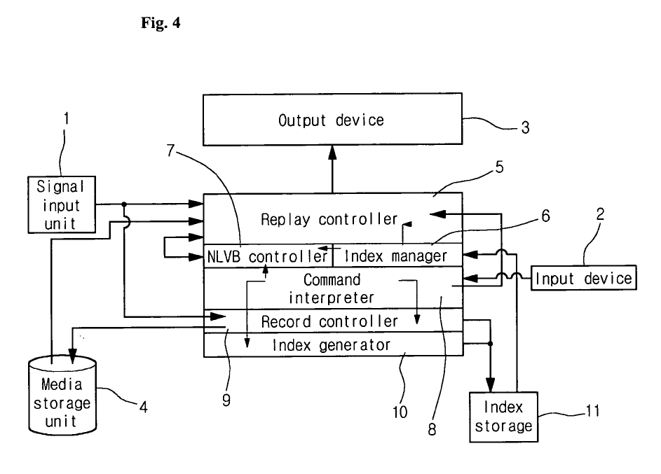

FIG. 4 is a block diagram of a PVR system that includes a dynamic searching apparatus having a function of dynamic search of the video contents.

As shown in FIG. 4, the PVR system according to the present invention includes a signal input unit 1, an input device 2, an output device 3, a media storage unit 4, a replay controller 5, an index manager 6, a nonlinear video browsing (NLVB) controller 7, a command interpreter 8, a record controller 9, an index generator 10 and an index storage 11. The signal input unit 1 receives the video contents. The input device 2 delivers a command of a user. The output device 3 outputs the video contents. The media storage unit 4 stores an A/V stream inputted through the signal input unit 1 and a recorded stream.

The replay controller 5 outputs the video contents to the output unit 3, controls to replay the entire media, and provides a nonlinear video browsing function and fast-forward/fast-rewind functions. The nonlinear video browsing function includes a dynamic search using communication with the NLVB controller 7 or the index manager 6 if necessary. The index manager 6 delivers storage information on the video contents to the replay controller 5 so as to provide the fast-forward/fast-rewind functions, and provides the stored shot index information to the NLVB controller 7. The NLVB controller 7 communicates with the index storage 11 through the index manager 6 and determines to replay which portion under the control of the replay controller 5 at which speed. The command interpreter 8 delivers commands for replaying control, recording control, nonlinear video browsing control and indexing control to each control module. The record controller 9 controls to store the A/V source inputted through the signal input unit 1 in the media storage unit 4. The index generator 10 extracts shot index information of the video contents stored in the media storage unit 4 by the record controller 9. The index storage 11 stores the generated shot index information.

The PVR system can performs recording, indexing, viewing and nonlinear browsing at the same time.

The nonlinear browsing function includes dynamic search function and further includes a skimming function if necessary. The PVR system needs essentially the signal input unit 1, the replay controller 5, the record controller 9, the index storage 11, the index manager 6, the media storage unit 4, the command interpreter 8, the input device 2 and the output device 3 to enable record/view functions that are the basic PVR functions. To provide the dynamic search function of the present invention, the index generator 10, the index manager 6 and the index storage 11 are changed into modules that can process additional information in contrast to the conventional PVR. The nonlinear video browsing (NLVB) controller 7 is configured.

The signal input unit 1 is a source that receives the video contents. The output device 3 is a device such as a monitor and a speaker, which outputs the video contents.

The media storage unit 4 is a device that stores an A/V stream inputted through the signal input unit 1. The input device 2 is a device such as a keyboard and a remote controller, which delivers a command of a user to a system. The command interpreter 8 is a device that delivers commands for replaying control, recording control, nonlinear video browsing control and indexing control to each control module.

The index generator 10 stores, in the index storage 11, storage information on the video contents stored in the media storage unit 4 by the record controller 9, and generates index information of the video contents from A/V stream inputted through the signal input unit 1 by using an automatic video indexing algorithm to store the index information in the index storage or stores shot index information in the index storage 11 when there is shot index information inputted through the signal input unit 1.

Accordingly, the index storage 11 stores the storage information on the video contents and the shot index information. The index manager 6 delivers the storage information on the video contents to the replay controller 5 so as to provide a trick play such as the fast forward and the fast rewind, and provides the stored shot index information to the NLVB controller 7.

The record controller 9 provides the storage information on the recorded video contents to the index generator 10 and stores the inputted A/V stream in the media storage unit 4. The replay controller 5 outputs the video contents to the output unit 3, controls to replay the entire media, and provides a nonlinear video browsing function and the trick play by using communication with the NLVB controller 7 or the index storage 11 if necessary

The NLVB controller 7 is a module that communicates with the index storage 11 through the index manager 6 and determines to replay which portion under the control of the replay controller 5 at which speed.

The PVR system relevant to the dynamic search function will be described.

When the dynamic search request is inputted from the user through the input unit 2, the command interpreter 8 determines whether the inputted request is the request for dynamic search function and informs the replay controller 5 of the determination result.

The replay controller 5 communicates with the NLVB controller 7 to obtain segment information to be replayed and information on the video replay mode at the request for dynamic search.

The NLVB controller 7 determines to replay which section at which speed on the basis of the shot index information inputted through the index manager 6 and the current replay location of the video contents delivered by the replay controller 5 and delivers the determination result to the replay controller 5.

Then, the replay controller 5 replays the corresponding portion of the video contents in the media storage unit 4 according to the designated method.

The NLVB controller 7 continues to search the video contents for the current replay location and perform the fast forward and the normal replay alternatively.

### INDUSTRIAL APPLICABILITY

Using the dynamic search function according to the present invention, the vertigo of the user is minimized in comparison with the conventional fast forward. The user can exactly search the video contents for the wished location in the approximately same time.

In contrast to the conventional skimming method in which summary information is provided and the portion to be determined to be unnecessary is skipped, since all the sections are replayed in the present invention, the dynamic search function according to the present invention can prevent the user from skipping erroneously due to erroneous shot index or skipping erroneously the main segment by a skimming system due to erroneous determination so that it is very advantageous to search.

Since the general fast forward and skimming have their own availabilities, if one system provides both the above-mentioned basic function and the dynamic search function of the present invention at the same time, very useful system can be constructed.

Since the dynamic search function of the present invention treats only the shot index information as an additional input, the dynamic searching apparatus of video contents can be easily configured by merely adding an indexing module and a dynamic search control module to the conventional PVR system. When the shot index generator for the conventional skimming is included in a system, the system can provide the dynamic searching function by adding the dynamic searching control module to the system.

While the present invention has been described and illustrated herein with reference to the preferred embodiments thereof, it will be apparent to those skilled in the art that various modifications and variations can be made therein without departing from the spirit and scope of the invention. Thus, it is intended that the present invention cover the modifications and variations of this invention that come within the scope of the appended claims and their equivalents.

1. A dynamic searching method of video contents comprising the steps of:
(a) determining a normal replay section and a fast forward replay section with considering shot index information and a current replay location; and
(b) replaying the video contents from the current replay location at corresponding speeds according to the determined sections.

2. The dynamic method of claim 1, wherein the step (b) comprises the steps of:
(b-1) fast-forwarding the video contents from the current location at a speed as fast as the replay speed of the fast forward replay section; and
(b-2) replaying the video contents at a normal speed as fast as the speed of the normal replay section when a replay location of the video contents accords with a start location of the normal replay section.

3. The dynamic method of claim 1, wherein the normal replay section is determined using a start location and length information obtained from the shot index information.

4. The dynamic method of claim 1, wherein, in the normal replay section, audio contents as well as the video contents are replayed at a normal speed.

5. The dynamic method of claim 1, wherein the shot index information comprises section information in a stream for an individual shot that is a physical editing unit of the video contents.

6. The dynamic method of claim 1, wherein the replay mode is switched from the normal replay to the fast forward replay in any one case selected from the group consisting of a case that a user clearly requests the fast forward replay during the normal replay in a dynamic search mode, a case that the user requests a dynamic search function during the normal replay, and a case that a predetermined amount of the video contents has been completely replayed at a normal speed in a dynamic search.

7. The dynamic method of claim 1, wherein the replay mode is automatically switched from the normal replay into the fast forward after a predetermined amount of the video contents has been replayed at a normal speed during a dynamic search, and
the amount of the video contents to be replayed at the normal speed corresponds to an entire selected shot.

8. The dynamic method of claim 1, wherein the replay mode is automatically switched from the normal replay into the fast forward after a predetermined amount of the video contents has been replayed at a normal speed during a dynamic search, and
the amount of the video contents to be replayed at the normal speed is an amount designated in a first half of a selected shot regardless of shot length.

9. The dynamic method of claim 1, wherein the replay mode is switched from the fast forward replay to the normal replay in any one case selected from the group consisting of a case that a user clearly requests the normal replay during the fast forward in a dynamic search mode, a case that a replay location of the video contents reaches a start location of a shot whose normal replay section is long during the fast forward for the dynamic search.

10. The dynamic method of claim 1, wherein the replay mode is automatically switched from the fast forward into the normal replay during the fast forward for a dynamic search,
a current replay location of the video contents is a start location of the normal replay, and
a shot to begin to be replayed at a normal speed is selected as a shot whose length is larger than a predetermined threshold, the length being calculated based on shot section information (start location and end location) in the shot index information.

11. The dynamic method of claim 1, wherein the replay mode is automatically switched from the fast forward into the normal replay during the fast forward for a dynamic search,
a current replay location of the video contents is a start location of the normal replay, and
a shot to begin to be replayed at a normal speed is selected as a shot whose division result is larger than a predetermined threshold, the division result being obtained by dividing length calculated based on shot section information (start location and end location) in the shot index information by an average of lengths of surrounding shots.

12. The dynamic method of claim 1, wherein, when the video contents are fast-forwarded for more than a predetermined period defined in the dynamic search, the video contents automatically begin to be replayed at a normal speed during the fast forward.

13. A dynamic searching method of video contents comprising the steps of:
(a) when a dynamic search is requested during a video browsing, determining a normal replay section with considering shot index information and a current replay location of video contents;
(b) fast-forwarding the video contents at a high speed from the current replay location to a start location of the normal replay section;
(c) replaying the video contents at a normal speed as fast as the speed of the normal replay section when a replay location of the video contents is a start location of the normal replay section; and
(d) when the replay of the video contents on the normal replay section is completed, repeatedly performing the steps (a) to (c).

14. The dynamic method of claim 13, wherein, in the normal replay section, audio contents as well as the video contents are replayed at a normal speed.

15. The dynamic method of claim 13, wherein the shot index information comprises section information in a stream for an individual shot that is a physical editing unit of the video contents.

16. The dynamic method of claim 13, wherein the replay mode is switched from the normal replay to the fast forward replay in any one case selected from the group consisting of a case that a user clearly requests the fast forward replay during the normal replay in a dynamic search mode, a case that the user requests a dynamic search function during the normal replay, and a case that a predetermined amount of the video contents has been completely replayed at a normal speed in a dynamic search.

17. The dynamic method of claim 13, wherein the replay mode is switched from the fast forward replay to the normal replay in any one case selected from the group consisting of a case that a user clearly requests the normal replay during the fast forward in a dynamic search mode, a case that a replay location of the video contents reaches a start location of a shot whose normal replay section is long during the fast forward for the dynamic search.

18. A dynamic searching apparatus of video contents comprising:
a media storage unit for storing video contents;
an index storage for storing shot index information on the video contents;
an index generator for generating shot index information of the video contents;
a controller for determining a normal replay section and a fast forward replay section by using the shot index information, and controlling to replay the video contents according to the determined sections; and
an output unit for outputting the replayed video contents.

19. The dynamic apparatus of claim 18, wherein the controller comprises:
a command interpreter for generating commands for replaying control, recording control, nonlinear video browsing control and indexing control to provide functions of record, index generation, replay and dynamic search;
a record controller for controlling to store the video contents in the media storage unit;
a replay controller for outputting the video contents to the output unit, controlling to replay the entire video contents, and providing a nonlinear video browsing function and fast-forward/fast-rewind functions; and
an index manager for delivering storage information on the video contents to the replay controller to provide the fast-forward/fast-rewind functions, and providing the shot index information to the nonlinear video browsing controller.
